(19) United States
(12) Patent Application Publication
(10) Pub. No.: US 2023/0023613 A1
(43) Pub. Date: Jan. 26, 2023

(54) DISTRIBUTING TRANSACTION BASED REWARDS TO USER DESIGNATED BENEFICIARIES

(71) Applicant: Social Ventures Inc., Santa Fe, NM (US)

(72) Inventor: DAVID MILES, SANTA FE, NM (US)

(21) Appl. No.: 17/865,756

(22) Filed: Jul. 15, 2022

Related U.S. Application Data
(60) Provisional application No. 63/222,401, filed on Jul. 15, 2021.

(51) Int. Cl. G06Q 30/02; G06Q 20/24

(52) U.S. Cl. CPC G06Q 30/0215; G06Q 20/24

(57) ABSTRACT

A system and method enable participants of a program to specify beneficiaries/recipients to receive a percentage of the rewards earned by such participation. For example, cashback rewards for both physical and virtual debit and credit card transactions earned by the cardholder may be issued to the party specified as a beneficiary/recipient. In some embodiments, the subject technology may be tied to an online host platform which runs the application process, the card transaction tracking process, and rewards distribution process.

### CROSS-REFERENCE TO RELATED APPLICATION

This application claims benefit under 35 U.S.C. § 119(e) of U.S. Provisional Application having Ser. No. 63/222,401 filed Jul. 15, 2021, which is hereby incorporated by reference herein in its entirety.

### FIELD

The subject disclosure relates to data processing systems, and more particularly, to a system and process for distributing transaction based rewards to user designated beneficiaries.

### BACKGROUND

Conventional transaction based rewards systems generally include the following steps. An entity (individual or business) learns about a card program. The entity applies for the card. A program administrator evaluates the applicant's application based on their business model and statutory regulations (for example, KYC etc.). If the application data falls outside of the business model and/or statutory regulations, the application is denied. Otherwise, a card is issued to the applicant and the entity becomes a cardholder in the card program.

Some existing programs include:

Affinity Cards

The Susan G Komen foundation card provides card holders $3 and 0.08% of all retail purchases in the first 90 days of account opening.

The World Wildlife Fund card.

The Aspiration.com program rounds up every transaction to the nearest dollar. The difference in actual transaction cost and rounded up cost is used fund a program to plant trees.

These cards are typically tied to donations to one recipient or cause.

Charity Charge

Card programs under this model are primarily focused on providing a card to non-profits (must be non-profit and operational for 2 years). Also offers a card that that allows cardholders to donate their cashback to up to 3 of 950 defined charities.

In another model, some airlines/hotel chains do permit points to be donated to select charitable causes.

### SUMMARY

In one aspect of the disclosure, a system and method enable participants of a credit/debit card program to specify beneficiaries/recipients to receive a percentage of the rewards earned by such participation. For example, cashback rewards for both physical and virtual debit and credit card transactions earned by the cardholder may be issued to the person or entity specified by the beneficiary/recipient. In some embodiments, the subject technology may be tied to an online host platform which runs the application process, the card transaction tracking process, and rewards distribution process.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

FIG. 1 is a block diagram of a computer network for administering user designated recipients of card issued rewards, according to embodiments of the subject technology.

FIG. 2 is a flowchart of a method for determining and automatically distributing user designated cash back reward to recipients according to an illustrative embodiment.

FIG. 3 is a flowchart of a process for issuing credit card rewards to third party entities consistent with an embodiment.

FIG. 4 is a block diagram of a computing device consistent with an embodiment.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be apparent to those skilled in the art that the subject technology may be practiced without these specific details. Like or similar components are labeled with identical element numbers for ease of understanding.

### Definitions

TABLE 1

| Term | Current Use case | Other Use Cases |
|---|---|---|
| Program | Bank | Airline, Hotel |
| Administrator | | Chain, Store |
| Program | XYZ Debit or | Flight/Stay |
| | Credit Card | Loyalty, Other Points |
| Card | Physical or Virtual | Physical, Virtual, or |
| | Card | A/C number |
| Reward | Percentage of | Cash back or Points |
| | qualifying transaction | towards flights, hotel |
| | | stays, etc. |
| Interval | Monthly Reward or | Varies |
| | Issuance Frequency | |
| Applicant | An individual or | An individual or |
| | Business Entity | Business Entity |
| Cardholder | Cardholder | Member |
| Recipient | Charity/other entity | Charity/cause to |
| | to receive reward | receive reward |
| Reward Distributor | Social Ventures | Airline, Hotel |
| | Inc. (Could also be the | Chain |
| | Program Administrator) | |
| Attribute | A rule defined by | |
| | the cardholder for | |
| | distribution of a reward. | |

In addition to the above table, as used herein, the terms “beneficiary” and “recipient” may be used interchangeably and refer to the same party (an individual or entity which receives the reward benefit and/or money from a cardholder's account).

In general, and referring to the Figures, exemplary embodiments of the subject technology system enable participants of a program to specify beneficiaries/recipients that will receive a percentage of the rewards earned by such participation by the cardholder. In an exemplary embodiment, cashback rewards for both physical and virtual debit and credit card transactions earned by the cardholder may be issued to the party specified by the cardholder. In some embodiments, the subject technology may be tied to an online host platform which runs the application process, the card transaction tracking process, and rewards distribution process. A host server (or group of servers) may run the aforementioned processes through a computer and/or telecommunications network.

During a card application/registration process (and at any time thereafter), the Applicant can (through an online user interface):

a. Browse/search our dynamic managed list of recipients by keyword, name, location, geographical influence, size etc.

b. Enter their own recipient(s) and provide the recipient contact information. The card applicant/holder can designate the recipient(s) as “private” or “public”. A “public” designation may make the recipient(s) visible and discoverable to others on the platform.

c. Discover recipients created by other cardholders who were marked as “Public”. As may be appreciated, this may allow groups to assist, for example, a crowd funding campaign through their everyday purchases.

III. In some embodiments, the applicant/cardholder may select multiple recipients and designate percentages, (and other attributes defined below) which the platform will track and distribute accordingly from the account accrued rewards.

IV. Additionally, the applicant/cardholder may elect to have their contact information shared with the recipient.

V. The platform administration will contact new recipients, to determine a payment remittance method.

VI. As rewards are calculated at the interval period, they will be apportioned based on the defined percentages (and other attributes) and distributed to the recipients electronically.

VII. Cardholders may change recipients (and other attributes) during any interval to take effect on the next interval cycle.

Significant Features in this System

As will be appreciated, features of the subject technology provide a non-conventional step(s) in the method of processing credit/debit card transaction and rewards distribution. Generally speaking, a card issuer designates the card holder or a pre-designated third party as a recipient. Thus, there is an inflexibility in the distribution of rewards generated. The subject technology in comparison, allows the card holder to designate the rewards recipient, and in some embodiments, multiple recipients with variable distributions, providing a lot more flexibility in the issuance of recipient rewards associated with the card holder. Attributes of the system include for example:

1. An ability to BYOC (Bring Your Own Cause) which does not need to be a charity.

2. An ability to create, share and participate in passive crowdfunding mechanisms for any cause.

For example:

a. Parents collaborating to donate funds to their kids' elementary teacher for school supplies.

b. Contributing to a GoFundMe-like medical fund.

c. Create a family/group vacation fund.

d. Contribute to a 529 educational fund.

e. Invest in fractional share investment platforms.

f. Payoff student debt.

Additional Explanation of Distribution Options

Flexibility is key. Through the host platform's control panel,

Cardholders can structure their reward distribution(s) to recipient(s).

1. Search for or create recipient.
2. Set percentage of reward to go to recipient at each interval. A default distribution may be 100% (Cardholder total active percentage rewards may not exceed 100%).
3. Set start date and duration for this recipient. Default “immediately” and “until cancelled”.
4. Set a cap limit for total amount distributed to this recipient by month or lifetime. Default $0.
5. Set a rollup amount for distributions to this recipient. This feature allows the Cardholder to set a minimum amount before distribution. For example, for a fractional share recipient there may be a minimum amount requirement of $10. This feature supports that. Default $0.
6. Set a Failed Goal Action. A Cardholder may define a set of Attributes that fail. For example, a 3 month duration with a Rollup amount of $100. If, after 3 months $100 has not been accumulated in rewards the cardholder must determine what happens to those funds. Some example, options include: 1) Send to Cardholder balance, or 2) Send “as-is” to Recipient anyway. Default to cardholder balance.

This flexibility permits cardholders to build simple or complex constructs for Reward distribution such as:

1. Distribute 100% of my Rewards to “Red Cross” (or another charity).

a. (All Rewards to Red Cross)

2. Distribute 100% of my Rewards up to $100 to “A & B's Honeymoon Fund” rolled up to $100.

a. ($100 to “A & B's Honeymoon Fund” once I've accumulated $100 in rewards).

3. Distribute 50% of my Rewards to “My kid's school teacher” and 50% to “My kid's 529 plan”.

a. (Rewards split equally between Cardholder's kid's school teacher and their 529 plan).

4. Distribute 100% of my Rewards to Fractional Share Broker rolled up to $10

a. (All Rewards to Fractional Share Broker but only when accumulation is $10 or more)

5. Distribute 100% of my Rewards to “Local Food Bank” from May to October Distribute 50% of my Rewards to “Local Food Bank” from November to April AND 50% to “Local Homeless Shelter” from November to April

a. (All Rewards to “Local Food Bank” during warmer months, split 50/50 between “Local Food Bank” and “Local Homeless Shelter” during colder months).

All Rewards will be held by either Program Administrator or Reward Administrator (or potentially split between both) until distribution at the interval either to a recipient or back to the cardholder due to a Failed Goal Action.

In the event that attributes defined by a cardholder, and the accumulated reward amount for distribution results in an uneven/irregular amount, amounts may be distributed to the recipients in the order in which the recipient list was created. For example: Recipient 1 receives 50%, Recipient 2 receives 35% and Recipient 3 receives 15%. A Reward of $5.01 has been accumulated. Rewards would be distributed as follows:

Recipient 1 $2.51. 50% of $5.01 would be $2.505, so rounded up to $2.51. Recipient 2 $1.76 35% would be $1.7535, so rounded up to $1.76. Recipient 3 $0.74 15% would be $0.7515 so ultimately lost little over 1 cent.

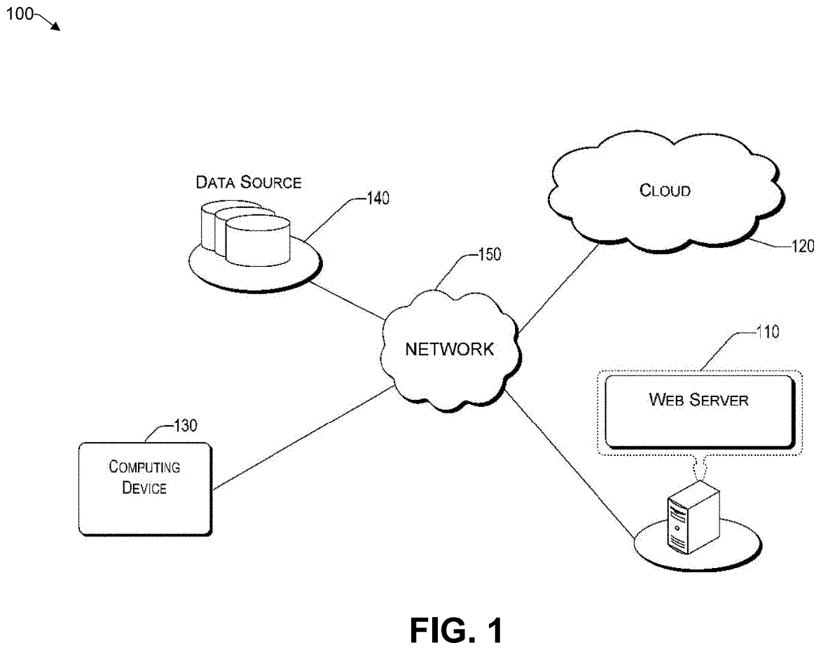

Referring now to the Figures, FIG. 1 shows a system embodiment in accordance with an exemplary embodiment. A system 100 generally includes a web server 110 which may host an online platform accessible to users through a network 150. The web server 110 may operate the backend processes of the cash back distribution to third party recipients described throughout this disclosure. In some embodiments, the web server 110 and/or the network 150 may reside within a cloud computing environment 120. Users may generally access the services available from the web server 110 by interfacing with their own computing device 130. In an exemplary use of the system 100, a user may access a software application within their computing device 130 which may include a user interface (UI) that accesses account options that include listing credit cards that participate in the distribution on rewards and third party recipients of those rewards. In some embodiments, the computing device 130 may be a point of sale terminal processing a purchase transaction. In some embodiments, the computing device 130 may be a server computer from a card issuer.

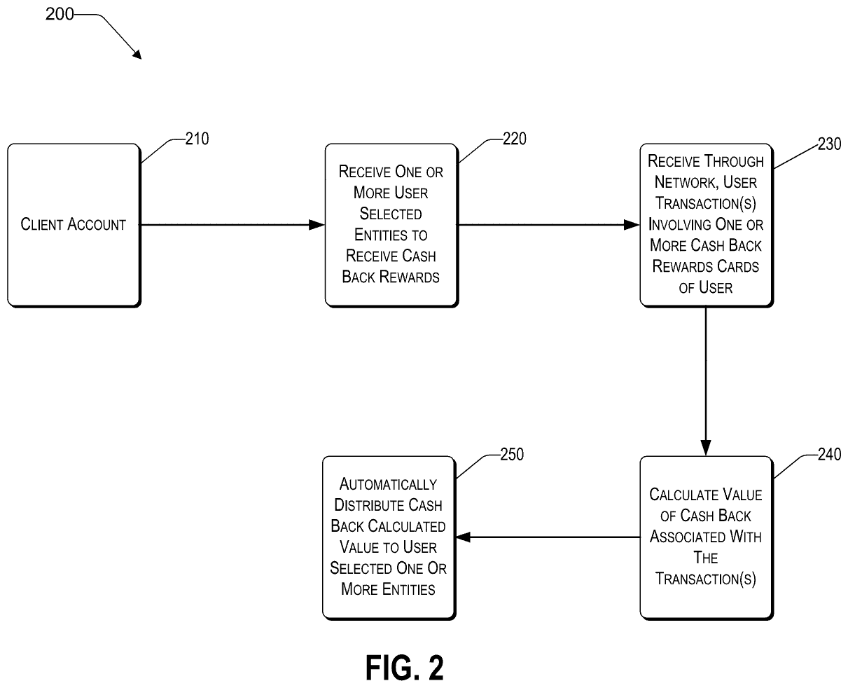

FIG. 2 shows a method 200 for determining and automatically distributing user designated cash back rewards to recipients. Block 210 represent a client user's account that is accessed by system embodiments. The client account may include for example, identification of the end user, cards associated with the user account, terms of cashback rewards for each card on file, a list of third party entities that receive a distribution from purchases by the end user, and rules for distribution. Block 220 represents the server 110 receiving from the end user, one or more entities to receive the end user's cash back rewards. The list of third party entities may be user selected and modified to include more entities or exclude entities through the UI described in FIG. 1. When the server 110 receives (block 230) a notice of the end user having made a purchase transaction using one of the cards on file, the server identifies the card used from the client account 210, and determines the terms of cash back and which third parties are to receive a distribution. In some embodiments, the end user may select/deselect, through the UI, third party recipients to receive (or not receive) the distribution associated with the instant transaction. In some embodiments, the end user may define percentages or portions of the distribution to the third parties receiving some of the reward for the specific transaction. In block 240, the server 110 calculates the amount of cashback generated by the purchase transaction. In block 250, the server 110 may automatically route the credit for the cashback to one or more of the end user's selected third party entities through the network.

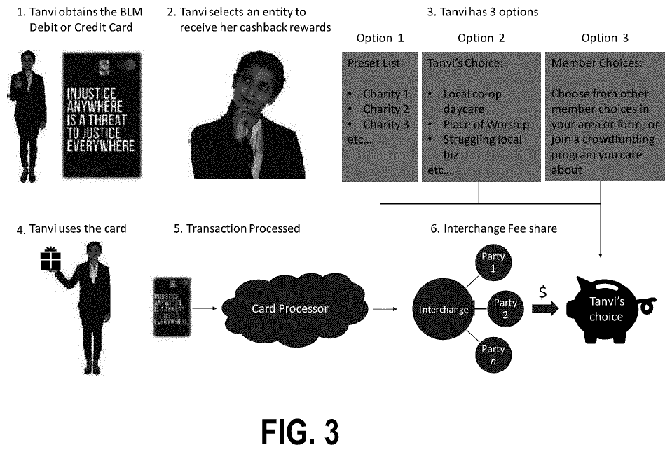

FIG. 3 shows a process similar to the method 200 except that the end user perspective is provided according to an illustrative embodiment. In one aspect, the end user may be presented with three options to select a third party recipient. The user may select from a pre-set list of charities provided by the host platform, select user defined entities, or select from other entities that may be associated with a cause or other non-charitable organization.

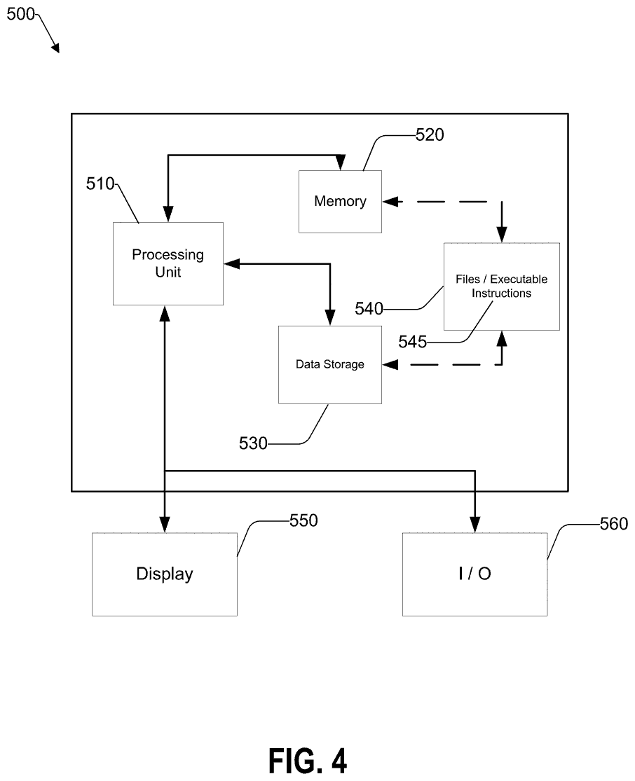

FIG. 4 shows a computing device 500 according to an exemplary embodiment. The computing device 500 may be for example, a computer system or a computer server. In the role of a server, a computing device 500 may provide the administration of the host platform for the rewards and distribution processes described above. In the role of a user device, the computing device 500 is generally not a server but may instead be desktop computers, tablet or laptop computers, all-in-one computer stations, a mobile computing device (for example, a smart phone, smart wearable devices (glasses, jewelry, watches, ear wear, etc.), or programmable electronics, which applicants and cardholders may use to apply, manage accounts, designate recipients, and track or manage rewards.

The components of the computer system or server, may include, but are not limited to, one or more processors or processing units 510, a system memory 520, data storage 530 (sometimes referred to as memory or memory storage), a computer program product 540 having a set of program modules 545 including files and executable instructions, and a bus system that couples various system components including the system memory 520 to the processor(s) 510. The system memory 520 may store for example, electronic files of the image objects to be printed.

The computing device 500 may be described in the general context of computer system executable instructions, such as the program modules 545 which represent a software embodiment of the system and processes described generally above. The program modules 545 generally carry out the functions and/or methodologies of embodiments as described above. The computing device 500 may typically include a variety of computer system readable media. Such media could be chosen from any available media that is accessible by the computing device 500, including non-transitory, volatile and non-volatile media, removable and non-removable media for use by or in connection with an instruction execution system, apparatus, or device. A computer readable storage medium may be, for example, but not limited to, an electronic, magnetic, optical, electromagnetic, infrared, or semiconductor system, apparatus, or device, or any suitable combination of the foregoing. The system memory 520 could include one or more computer system readable media in the form of volatile memory, such as a random-access memory (RAM) and/or a cache memory. By way of example only, the data storage system 530 may read from and write to a non-removable, non-volatile magnetic media device. The system memory 520 may include at least one program product 540 having a set of program modules 545 that are configured to carry out the functions of embodiments of the invention in the form of computer executable instructions. The program product/utility 540, having a set of program modules 545, may be stored in the system memory 520 by way of example, and not limitation, as an operating system, one or more application programs, other program modules, and program data. Some embodiments may generate an electronic user interface (viewable and controllable from a display 550).

The computing device 500 may communicate with one or more external devices including for example, an electronic display 550 which may in some embodiments be configured for tactile response as in a touch screen display. User input into the display 550 may be registered at the processor 510 and processed accordingly. Other devices may enable the computing device 500 to communicate with one or more other computing devices, either by hardwire or wirelessly. Such communication can occur via Input/Output (I/O) interfaces/ports 560. In some embodiments, the I/O interfaces/ports 560 may be specially configured to handle aspects of the embodiments described herein converting the computing device 500 into a special purpose machine.

The computing device 500, through the I/O interface/ports 560, may communicate with one or more networks such as a local area network (LAN), a general wide area network (WAN), and/or a public network (e.g., the Internet) via a network adapter as is commonly known in the art. Each of the operating system, one or more application programs, other program modules, and program data or some combination thereof, may include an implementation of a networking environment. In some embodiments, the computing device 500 may be a cloud computing node connected to a cloud computing network (not shown). The computer computing device 500 may be practiced in distributed cloud computing environments where tasks are performed by remote processing devices that are linked through a communications network. In a distributed cloud computing environment, program modules may be located in both local and remote computer system storage media including memory storage devices.

As will be appreciated by one skilled in the art, aspects of the disclosed invention may be embodied as a system, method or process, or computer program product. Accordingly, aspects of the disclosed invention may take the form of an entirely hardware embodiment, an entirely software embodiment (including firmware, resident software, micro-code, etc.) or an embodiment combining software and hardware aspects that may all generally be referred to herein as a “module”, “circuit”, or “system.” For example, a “memory module” may in some hardware embodiments be any one of the system memory 520, the data storage 530 or any combination thereof. Furthermore, aspects of the disclosed invention may take the form of a computer program product embodied in one or more computer readable media having computer readable program code embodied thereon.

Aspects of the disclosed invention are described above with reference to block diagrams of methods, apparatus (systems) and computer program products according to embodiments of the invention. It will be understood that each block of the block diagrams, and combinations of blocks in the flowchart illustrations and/or block diagrams, can be implemented by computer program instructions. These computer program instructions may be provided to the processor 510 of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks in the figures.

Those of skill in the art would appreciate that various components and blocks may be arranged differently (e.g., arranged in a different order, or partitioned in a different way) all without departing from the scope of the subject technology. The previous description is provided to enable any person skilled in the art to practice the various aspects described herein. The previous description provides various examples of the subject technology, and the subject technology is not limited to these examples. Various modifications to these aspects will be readily apparent to those skilled in the art, and the generic principles defined herein may be applied to other aspects.

Thus, the claims are not intended to be limited to the aspects shown herein, but are to be accorded the full scope consistent with the language of claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the invention.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.” Furthermore, to the extent that the term “include,” “have,” or the like is used in the description or the claims, such term is intended to be inclusive in a manner similar to the term “comprise” as “comprise” is interpreted when employed as a transitional word in a claim.

What is claimed is:

1. A process for distributing transaction based rewards to user designated beneficiaries, comprising:
receiving, by a computer server, a notice of a purchase transaction from and end user participant;
identifying an account associated with the end user participant;
identifying a credit card associated with the purchase transaction;
retrieving from a client account associated with the end user participant, rules defined by the end user participant for a distribution of cash back rewards associated with the identified credit card;
receiving from the end user participant through a user interface or retrieving from the account, one or more user selected third party recipients to receive the distribution of cash back rewards;
calculating by the computer server, the amount of cash back rewards for each user selected third party recipient, based on an amount associated with the purchase transaction; and
automatically distributing the calculated cash back reward to the one or more third party recipients.
